(19) United States
(12) Patent Application Publication
(10) Pub. No.: US 2010/0146334 A1
(43) Pub. Date: Jun. 10, 2010

(54) FAULT TOLERANT UPDATE PROPAGATION TO VIEWS

(75) Inventors: Hans-Arno JACOBSEN, Toronto (CA); Ramana YERNENI, Cupertino, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/331,737

(22) Filed: Dec. 10, 2008

(51) Int. Cl. G06F 11/14

(52) U.S. Cl. 714/15; 714/E11.113

(57) ABSTRACT

In a database system, derived data (often called view data or view tables) depends on other data, often called base data (or base tables). When base data on which derived data depends is updated, including changes, additions, and/or deletions, those updates need to be propagated to derived data. Some types of updates, if repeated, result in an incorrect view data state; these updates are termed non-idempotent. To avoid repeating non-idempotent view data updates, signatures are computed that are repeatable, but yet unique to base data on which the view data is based, the view data being updated, and sequence information for updates to the base data (where applicable) and sequence data for multiple changes to the view being updated. The signatures allow detection of view updates that were committed prior to a failure, but which were not confirmed as having been committed to a process that computes the view updates.

### BACKGROUND

### Related Art

The following generally relates to updating of database systems, and more particularly to maintaining consistency in database transactions during update propagation.

Modern database systems can comprise base tables that store directly updated data, and view tables that are derived from data obtained, directly or indirectly, from base tables. For example, a web store may use a base table for tracking inventory and another base table for tracking customer orders, and another for tracking customer biographical information. A person maintaining the web store may, for example, desire to analyze the data to prove or disprove certain hypotheses, such as whether a certain promotion was or would be successful, given previous order behavior, and other information known about their customers.

The base tables are updated as changes are required to be reflected in the data. In other words, the base tables generally track or attempt to track facts, such as order placement, inventory, addresses, click history, and any number of other conceivable facts that may be desirable to store for future analysis or use.

Thus, when base tables are updated, view tables that depend on data in those updated base tables also need to be updated to reflect those updates. Often, because the view tables are used for analytics, such updates can occur “off-line”, to avoid burdening the systems that are supposed to be most responsive to users. For example, adjustments to a base table tracking inventory for a product need to be made when a unit of the product is sold. There may be a number of views that use a current inventory for that product. However, if each of those views were updated every time a unit of that product were sold (and a unit for each of hundreds or thousands of other products), then the updating may be a substantial burden on one or more of the system components.

It would be desirable to distribute updating and other processing of that type among a number of computing nodes. However, there are many concerns with and impediments to implementing such a distribution strategy. One such concern is to maintain accuracy during updates, including in situations where faults occur.

### SUMMARY

An example of the subject matter to which these disclosures relate is generating signatures that can be used for uniquely identifying a non-idempotent update to a view table. The signature includes base information from which the view update was derived. The signature can be used to confirm that the non-idempotent update is not incorrectly repeated during recovery from a data base failure.

A particular aspect includes a method for use in a database system comprising base tables and view tables derived from data in the base tables. The method comprises determining, in a view manager, responsively to an update to a base table, updates to view tables having data derived from the updated base table. The method also comprises generating, in the view manager, a respective signature for each non-idempotent view table update. Each signature uniquely identifies the updated base table, the view table for which the update is intended, and includes update sequence information. The method also comprises providing the view table updates and the signatures to a database resource for commitment to storage of the view table updates. The database resource can generate confirmations of commitments for provision to the view manager. The method also comprises, during recovery from an operational excursion, using the signatures in identifying any non-idempotent view table update that was committed prior to the failure, but for which confirmation of commitment was not acted upon by the view manager.

Particular implementations can form signatures including a base table name, a view table name, and a key from the base table. Other particular examples can include sequence information indicative of a number of times that the base table record was updated, and view sequence information uniquely identifying each view update of a number of view updates generated in response to a particular base update.

Another aspect includes a method of committing to storage updates to derived data. The method comprises receiving a view data element to be written to an identified derived data view and receiving a signature associated with the data element, the signature uniquely indicative of a base table record, a view table of which the view data element is a part, and sequence information relating to one or more of a number of times that the base table record was updated and a view sequence number. The method also comprises initiating a process of committing the view data element to storage. The process includes comparing the signature with signatures previously received for other view data elements; and rejecting the view data element as being repetitive if the signature matches with any previously received signature.

Other aspects include computer readable media embodying instructions for performing such methods, and systems comprising structure for implementing methods according to these examples.

### BRIEF DESCRIPTION OF THE DRAWINGS

FIG. 1 illustrates a database system where applications can update base table data, and updates to such data are provided to a view manager for updating derived data (view data) in view data storage;

FIG. 2 illustrates an example of base data updates flowing to the view manager, which computes updates to view data, and provides the updates to view data storage for commitment;

FIG. 3 illustrates a signal flow diagram between a view manager and view data storage;

FIGS. 4 and 5 respectively illustrate a first view program and a second view program using fields from a base data update and respective view data in computing view data updates, including signatures for association with the update information to be provided to view storage resources;

FIGS. 6 and 7 illustrate storage/maintenance of base data updates pending commitment and confirmation of commitment of view data updates from the view programs of FIGS. 4 and 5;

FIG. 8 illustrates an example of operating steps in a method that can include recovering from an operation excursion, such as failure of the view manager, or failure to receive an acknowledgement of a view update commitments; and

FIG. 9 illustrates an example of a system that can be used in implementing component and method aspects described above.

### DETAILED DESCRIPTION

Updates between base tables and view tables can be categorized in different ways. One categorization is whether or not a view table update is an idempotent or non-idempotent update. An idempotent update is one that can be repeated without causing an incorrect state in the view table. For example, repetitively changing an e-mail address to the same address, and deleting a record are both idempotent updates, because no matter how many times one changes an address to the same address, the data remains correct, and likewise, trying to delete a deleted record causes no incorrect change.

However, incrementing a value is a basic example of a non-idempotent update, because it requires reading current value, and then writing back a new value. Thus, if “add one to x”, where x is a value in a record, was intended to be performed once, but it was performed twice, then x now is incorrect.

Repetition of a non-idempotent update, and/or failure to execute a non-idempotent update are both dangerous, because there is a chance that the update was effected before the failure state, but there was not yet a confirmation that such update was effected. Therefore, a system component determining the view table updates may not be aware that commitment of a given view table update occurred. In the case of non-idempotent updates, redriving the update if already updated, and not redriving an update not committed causes incorrect results.

One way to resolve the problem would be to rebuild the entire view table from scratch, using each and every update that occurred from a last known good point. This solution would be very time consuming and expensive for any complex view table. Therefore, other solutions to the problem of proper treatment of non-idempotent view table updates during failure recovery would be helpful.

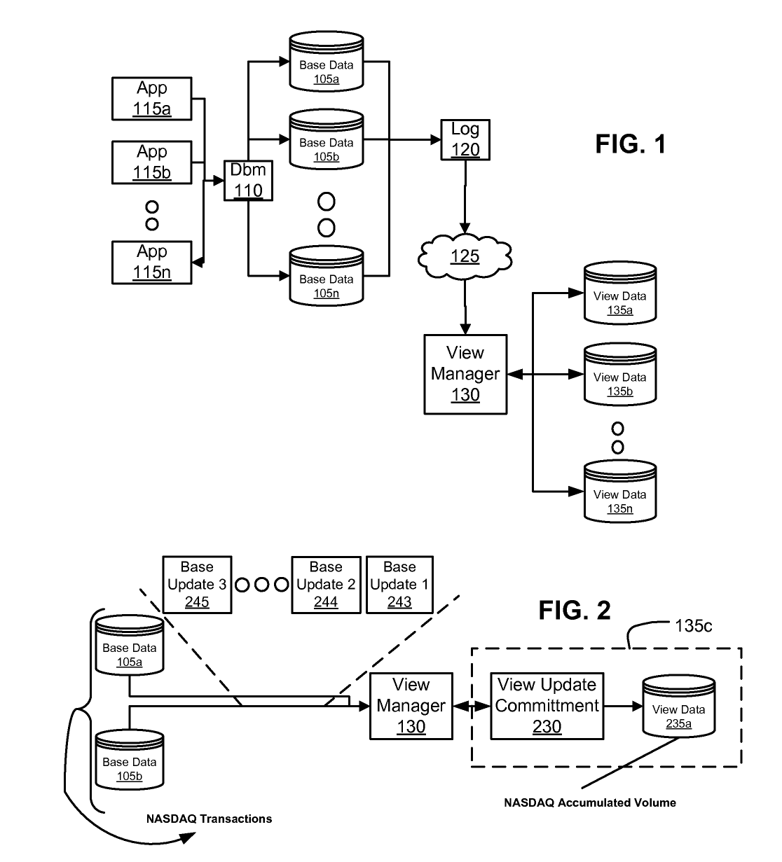

As such, a focus of the present description is providing approaches that can be embodied in methods and systems that help avoid incorrectly repeating or skipping non-idempotent transactions or updates in recovery from operational excursions, such as failure conditions or during failure recovery. To that end, FIG. 1 illustrates a simplified architecture of a system comprising base data that can be updated by applications, where such updates generate log updates that are propagated to view programs, which generate updates to view records.

Applications 115a-115n generate information that is stored in and used to modify data stored in base data 105a-105n. Storage of such base data can be managed by a database manager 110. For example, base table 1 below is an abbreviated example of base data comprising stock purchase/sale transactions. In such an example, applications 115a-115n can be various sources of such data, such as applications that receive orders from clients, as well as information feeds from other sources of such information.

TABLE 1
NASDAQ Transactions

| | | | Number | | | | Account | Seq. |
|---|---|---|---|---|---|---|---|---|
| Key | Ticker | Action | Shares | Date | Time | Price | No. | # |
| Record | INTC | Buy | 100 | Jun. 24, 2008 | 10:01:10 | 22.81 | A3432 | 1 |
| key 1 | | | | | | | | |
| Record | YHOO | Buy | 500 | Jun. 24, 2008 | 10:01:15 | 24.56 | A3432 | 1 |
| key 2 | | | | | | | | |
| Record | INTC | Sell | 200 | Jun. 24, 2008 | 10:02:10 | 22.85 | A3432 | 1 |
| key 3 | | | | | | | | |
| | | | | . . . | | | | |
| Record | YHOO | Sell | 100 | Jun. 24, 2008 | 10:01:22 | 24.65 | A3432 | 1 |
| key n | | | | | | | | |

Base data, as shown in the example of table 1, can include a number of records (in table 1, rows), each often including a key that uniquely identifies a particular set of information within that base table (i.e., a key value is unique within that base table). Each record can include an association with a number of discrete items of information, which are arranged for illustration in columns in table 1. In table 1, the base data relates to NASDAQ stock transaction, where each record is a separate transaction for a stock. For example, the record associated with Key 1 is a Buy of 100 shares of INTC, and included with that record is information about the price paid, the date, and time, as well as an account for which the stock was purchased.

When data stored in base data 105a-105n changes or is added/deleted, an update representative of such information is provided to a log 120. Log 120 can be a queue that accepts updates as they are generated from base data 105a-150n, and preferably represents a temporally correct ordering of the changes to base data. Log 120 can provide the updates over a network 125 to a view manager 130 (can be a LAN, WAN, or any mixture of other communications mediums), which comprises computing resources for executing any of a variety of programs for using the updates to base data to maintain a variety of views that are stored in view data storage 135a-135n. Log 120 also can represent a computer readable medium storing base table updates, as well as a combination of a network connection between respective base data 105a-105n and a persistent storage for the updates outputted from base data 105a-105n.

For example, Table 2 represents a view of accumulated volume of NASDAQ transactions, which to remain current would require updating in response to transactions being added to Base Table 1, above. Table 2 illustrates that each record of the view also can have an identifying key, and can include information, such as a ticker symbol, a total number of shares traded, and information about a last trade.

TABLE 2
NASDAQ Accumulated Volume

| | | | | | Last |
|---|---|---|---|---|---|
| | | Total Number of | | Last Trade | Trade |
| Key | Ticker | Shares Traded | Date | Time | Size |
| Key 1 | INTC | 5,687,150 | Jun. 24, 2008 | 10:01:00 | 500 |
| Key 2 | YHOO | 3,485,981 | Jun. 24, 2008 | 10:01:15 | 500 |

. . .

Table 3, below, is a view table relating to status of a particular account that could be maintained at a brokerage, for example. Table 3 also can have keys for different records maintained in the view, which each are associated with different information, which can be derived from information ultimately obtained from base data. For example, the record associated with key 1 indicates that the account currently has 300 shares of INTC, indicates last trade status, and also can indicate other derived information such as gain or loss. It also would be apparent that such information requires updating based on changes occurring in base data.

TABLE 3
A3432 Account Status

| | | Number of | Last | | | |
|---|---|---|---|---|---|---|
| | | Shares | Trade | Average | Current | Gain |
| Key | Ticker | Owned | Date | Price | Price | (Loss) |
| Key 1 | INTC | 300 | Jun. 24, | 23.31 | 22.81 | (100.00) |
| | | | 2008 | | | |
| Key 2 | YHOO | 500 | Jun. 24, | 24.56 | 24.56 | 0.00 |
| | | | 2008 | | | |

. . .

For clarity, these examples are abbreviated in their extent; most practical base tables and view tables are substantially larger. Also, a wide variety of applications of view data and base data exist, and the isolated example of such stock transactions implies no limitation as to the applicability of any example or aspect described herein.

In FIG. 2, base data storage 105a and 105b can store data for Table 1, above, NASDAQ stock transactions. Since the information describing NASDAQ stock transactions is extensive, base data storage 105a and 105b may be comprised of a large number of storage resources for storing all the records required to represent such information. In FIG. 2, view manager receives base updates, respectively numbered 243, 244, and 245. These base updates 243-245 can be generated as a result of NASDAQ stock transactions, as illustrated in preceding Table 1. Receiving can include accessing base updates from storage.

View manager 130 executes view updating programs that each describe manipulations to be done to data to arrive at a particular view, e.g. the accumulated volume view of Table 2 (more complicated views can be provided, and continuing with the example of stock transactions, such views may include technical analysis, such as moving averages, and so on.) In other applications, other views can be provided according to the needs presented. For example, inventory tracking applications can track totals on hand for certain products, web advertising can track page clicks, and so on.

In cases where view manager 130 is performing an increment operation on a variable, such that a value of a variable needs to be increased by another amount, and similar operations, view manager first reads a value for that variable, increments it, and then provides it to a system or process that writes it back. In other words, there are usually multiple separate processes, logically and/or physically, that are involved in finally getting an increment to a variable committed to storage. So, between a time when view manager 130 dispatches data to be committed to storage and a time when it receives a confirmation that the data was committed to storage, view manager 130 has no certainty as to whether or not data provided by it for commitment to storage actually was committed. For example, for the accumulated view of Table 2, view manager 130 may not be able to determine whether or not an accumulated volume for a certain ticker reflected a transaction or not. Accumulated volume is an imperfect example of the complexity of some view updates, because accumulated volume is an increasing number. Some views can have widely fluctuating quantities, for example, from which it is even more difficult to determine whether a given update is reflected in a current quantity.

Likewise, the system and/or process performing the commitment of the update to storage would not have information about the base table updates or other information used to arrive at the number which it was requested to commit to storage.

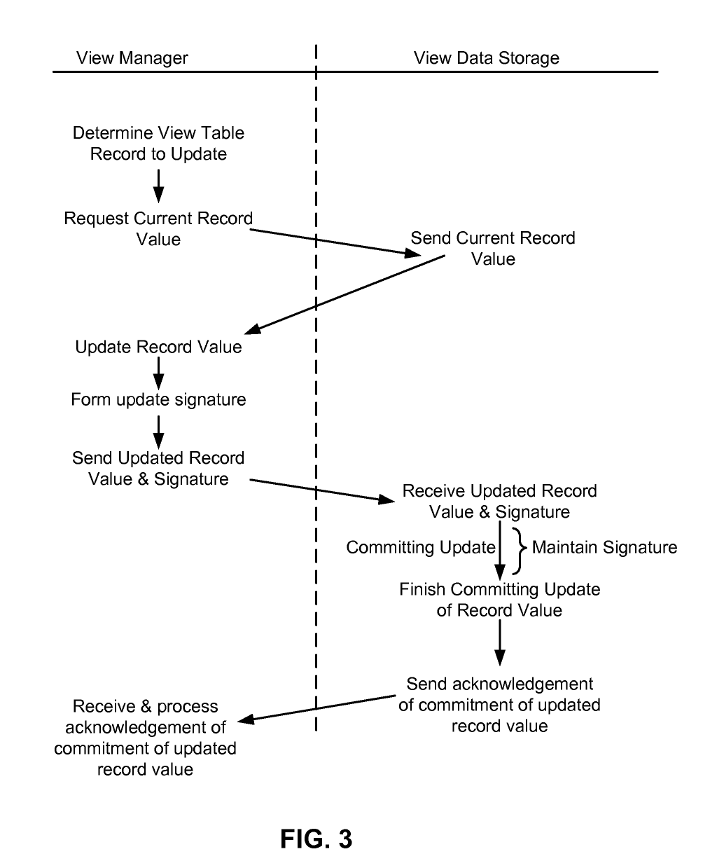

FIG. 3 shows information flow that can occur in a first example between view manager 130 and view data 135c (for example) when producing an update to view (derived) data based on new or updated base data. As described with respect to FIG. 2, view manager 130, under control of a program specified for updating a given set of derived data (a view), determines a view table record to update. For example, in response to receiving information that a NASDAQ stock was traded, the view record pertaining to total accumulated volume of NASDAQ shares traded should be incremented.

As explained above, for each base table update, view manager 130 determines one or more view tables to be updated. Also, within a given view table to be updated, there can be multiple distinct items of information that will be updated. Indexing information allowing each of these view updates to be distinguished also is used where necessary in the signatures explained in further detail below.

In order to increment the number of shares traded, a current number of shares traded needs to be read from view data storage 135c, and so a request is made for that information from view manager 130 to view data storage 135c. View data storage 135c responds with the information. Then, based on the number of shares presently traded, for which the accumulated number needs to be updated, view manager 130 increments the accumulated number.

Then, view manager 130 composes an update signature, described further below, and sends the updated value and the signature to view data storage 135c. View data storage 135c receives the updated value and signature, and begins to commit the updated value. Upon committing the updated value, view data storage 135c can send an acknowledgement to view manager 130. After receiving the acknowledgement, view manager 130 can take actions including allowing the base data corresponding to the now-updated view data to expire, or to delete such base data.

Regardless whether the manager 130 and the view data storage 135c are implemented as physically separate devices, or as separate processes, or some other implementation, there generally is communication of information for committing the view update and acknowledging that the view update was committed. In conditions where a failure occurs, it can be the case that a view table value was committed but that commitment was not yet registered, received, or acted upon by view manager 130. In such circumstances, view manager 130, without update signatures as described below, would not be able to determine whether a given base data change already was accounted for in derived data (view data).

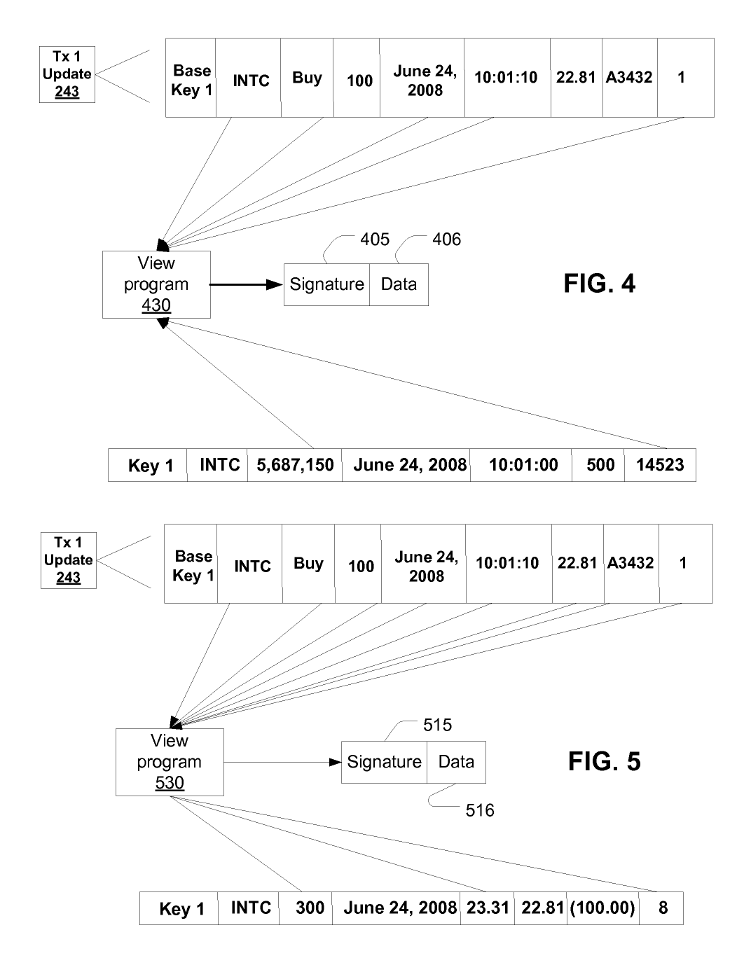

FIG. 4 and FIG. 5 are used in illustrating how view managers can produce view updates based on base data. FIG. 4 shows that update 243 (FIG. 2), bearing information relating to the update to base key 1 (Table 1, above) is provided to view update program 430, which executes in view manager 130, and which manages the updating of NASDAQ Accumulated Volume view. To produce the necessary view updates, program 1 accesses information including the ticker symbol, the number of shares, date, time, price, and potentially sequence information. Since the view does not depend on whether the transaction was a buy or a sell, that data need not be accessed by view program 430.

Also, since view program 430 is for updating accumulated volume, it must read the present share trade volume, which is illustrated as being 5,687,150 in the view table (see Table 2, row 1). Although view program 430 also updates last trade time, date and price information, the information presently stored in those view fields is not required to update the information presently in them. Also, the updating of these fields are idempotent transactions, assuming that facilities exist for maintaining the serial order of updates. For example, reapplying a temporally correct sequence of last trade time information ultimately will result in the correct value in that field, even if all of those updates were previously committed to view data storage. By contrast, reapplying trade volume updates will result in an incorrect figure for total number of shares traded, making that update non-idempotent.

Upon obtaining current share volume data, view program 430 can perform an addition operation on that data, producing new volume data 406, and which is associated with a signature 405 having characteristics described below.

Similarly, FIG. 5 shows that view program 530, for maintaining account status as shown in Table 3, receives update 243 as well (can simply be that both programs read relevant data from a location where data for update 243 is stored). View program 530 reads much of the same data as view program 430, except that it also needs more information about the transaction, in particular, whether the transaction was a buy or a sell. Also, view program 530 needs to read a value for shares currently held in that account. Other information required involves computation of gain/loss. There are different ways in which that calculation can be effected, and in this example, the average share price paid is accessed from view data. The previous average, and share holding, in view of the information from update 243 is used to calculate a new average and new account holding, which are provided as updates to be committed to storage (FIG. 2.) The update to the share holding information is represented by data 516 and its associated signature by 515 of FIG. 5.

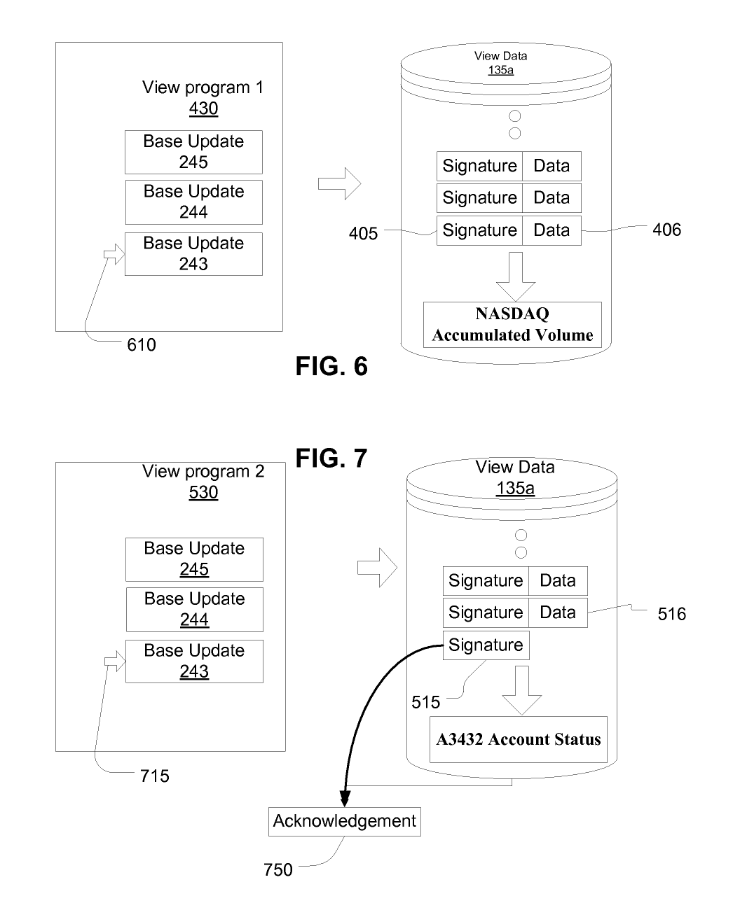

The base update data can be considered to be stored in persistent storage, available to each view manager using those base updates to effect view updates. Each of these view managers can maintain a pointer, or watermark or equivalent indication that it has processed the base updates to a given point. For example, in FIG. 6 and FIG. 7, below, respective pointers 610 and 715 indicate a current base update for which corresponding view updates have not yet been indicated as being committed. Then, upon receiving all notices of commitment for view updates corresponding to a given base update, such view manager can increment its indication that it now has finished with that base update. However, in the presence of operating excursions, there may be a number of view updates sent out by a view manager that have not been acknowledged.

To enable determining whether a given change or new item of base data was reflected in view data, view manager 130 can form a signature having properties as described below.

First, a given signature uniquely identifies to what base data (e.g., a base table) a given update corresponds. For example, base tables often are named. For example, a base table for NASDAQ stock transactions can be descriptively named NASDAQstocktx. When a record is added to that base table, an update can be generated, such as updates 243-245, depicted in FIG. 2, which can represent changes, deletions, and/or additions to data in base tables, e.g., transaction information added to Table 1, above.

Also, within a base table, each record has identifying information, and record identifying information also can be included in a signature to distinguish that record from other records in that base table. Also, a sequence number can be associated with a base table record so that updates to that base table record can be distinguished from each other based on that sequence number. Such a sequence number also can be used in a signature for identifying view updates corresponding to a particular base update.

A view update program may use one or more fields associated with a base table record to generate one or more updates to a view, and multiple views may be updated based on any given view update. So, a signature for association with any given view record should provide a basis for distinguishing between multiple updates to any given view, even if generated in response to a single base table record update, and also provide a basis for distinguishing between multiple different view updates based on a single base table record update.

One component of a signature according to these aspects provides an identifier of the view (e.g., NASDAQ accumulated volume) to which the update data corresponds, and a record, if applicable, in that view. For example, if the view NASDAQ accumulated volume tracks separate entries for each stock in that composite, then a signature would identify a particular key in that view. If a given view had only one updated record (e.g., if separate stocks were not tracked in that view), then only the view itself may need to be identified.

Another component of the signature should distinguish between multiple updates to the same view (or view record, if applicable), or updates to multiple view records corresponding to one base table update/view table combination. This component can be an index that increments for each update of that combination. The index can reset for each new base table update/view table combination (e.g., a new base table update that causes an update to the same view record, or the same base table update to a different view table all can have reset indexes). The index also can be a monotonically increasing sequence number for a number of updates processed by that view manager, although this would likely require more storage space for the signatures.

Table 4 provides examples of each of these signature components. For example, for the update to the record 1 of Table 1 (NASDAQ transactions) (identified by record key 1 in Table 1), a view manager maintaining a view for NASDAQ accumulated volume according to the fields of Table 2 can form the view updates and the signatures for those updates shown in the first three rows of Table 4 (the representation of the signatures in Table 4 is intended to be more human readable, for clarity, but signatures actually used in a system can take any of a variety of formats). Row 1 of Table 4 includes a signature that corresponds to a view update to the total number of shares traded for the INTC record of Table 2, based on the base table update generated for the first row of Table 1.

This signature includes the name of the base table to which the updated base data corresponds, a record within that base table (that transaction is identifiable in Table 1 with record key 1), and a sequence number of that base table update. Since the present example involves new base table transactions, these sequence numbers can be 1, 0 or even omitted, since in this application, record generally would not be updated (i.e., once this transaction occurred, further transactions are represented by new records, not revisions to this record). In other applications, the sequence number may be more important, and so it is maintained in the present example.

As illustrated in Table 4, the signature of row 1 includes view identifying information, including view table name information (nasdaqAV) and record information (appropriate where a given view table has more than 1 record). This signature also includes view update sequence information, which provides an indicator of which number view update the present view update is in a sequence of view updates produced for the given base table update/view table.

To further illustrate the signature formation, the signature of row 2 of Table 4 also corresponds to an update produced by the same view manager, in response to another record update from the same base update (record 3), and for the same record within the view. So, some aspects remain constant (e.g., base table identifying information, while the record key changes). The view manager sequence information is incremented with respect to the prior update from row 1. So, each of these updates is associated with signature information that can be repeatably created in response to the same base update information, but which is distinguishable from different view updates either for different view data or based on different base data.

As described above, several view updates were generated in response to the updated base information of Record 1 in Table 1. Not all of these updates are shown as having an associated signature in Table 4, because they are not all non-idempotent operations. For example, repeatedly storing a last transaction time ultimately will result in a correct last transaction time, so long as temporally correct ordering is maintained. Of course, if it were desired, signatures could be created and associated with both non-idempotent and idempotent updates.

Rows 3-4 of Table 4 illustrate further aspects of the signatures. Each of these rows shows that its view update corresponds to base data from the NASDAQTX base table, but from the second and nth records in that base table (the YHOO buy 500 and sell 100 transactions). Each of these base updates also generates multiple view updates to the view A3432 account status (the account for which the stock was purchased). However, not all of them are non-idempotent, and idempotent updates do not need a signature associated, although one can be provided. So, the signatures reflect the base table sourcing information (e.g., base table name, record identifier, and sequence info for that record, as appropriate), view table and view record (where appropriate) information, and view update sequence information, which is shown as increasing for each of the four updates.

View sequence information tracks different updates to a given view caused by a particular base update, allowing determination of which of these different view updates was or was not committed during recovery from an operational excursion. The view sequence information can be incremented only for non-idempotent updates, or for both kinds of updates. In an example, view sequence information tracks each update to a particular view generated for a given base update/view update combination. For example, a given base update can trigger a number of updates to a given view record, or updates to several view records within a given view. Each separate update triggered would have sequence information associated with it (e.g., in its corresponding signature).

As evident by comparing the signatures of rows 1-2 with those of rows 3-4, the base data prompting the view updates is one aspect distinguishing the signatures, other aspects are the base record information (which would apply in a case where the base table was the same), the views and view records (where applicable) to which each update applies.

In sum, each signature allows view updates to be distinguished from each other. This includes that multiple view updates involving the same base tables/records and view tables/records would have different sequence information, allowing those updates to be distinguished from each other. As such, although the examples here use names of view tables, and base tables, other handles can be used to identify base data and view data involved in a given base table update. What is desired are mappings that provide both a unique identifier for each view table update, while also being predictably generatable, such that no view table update can be confused for another, but to recover from a failure, the same combination of base table/view table/sequence information can be reproduced for use identifying repetitive non-idempotent updates.

TABLE 4

| Signature | Field identifier | Value |
|---|---|---|
| NASDAQTX.recordkey1.seq1.nasdaqAV.key1.1 | Total Number of Shares | 5,687,250 |
| | Traded | |
| NASDAQTX.recordkey3.seq1.nasdaqAV.key1.1 | Total Number of Shares | 5,687,450 |
| | Traded | |
| NASDAQTX.recordkey2.seq1.A3432AS.key1.1 | Total Shares Owned | 300 |
| NASDAQTX.recordkey4.seq1.A3432AS.key1.1 | Average Price | 23.31 |

Returning to the context and usage of the signatures described above, as shown in FIG. 2, each of these updates (those of FIGS. 4 and 5) and their associated signatures are provided to a storage resource operable for committing those updates to storage. For example, logic identified as view update commitment logic 230 can store the updates to view data in view data storage 235a.

While the updates are being committed, FIGS. 6 and 7 each illustrate that information about base table updates can be maintained accessible to the view programs forming their respective updates. View data storage 135a receives the updates and serially processes them. When view data resource 135a has finished committing a given update, then it generates and sends an acknowledgment of that commitment to the view program which generated that update. Acknowledgement 750 in FIG. 7 illustrates this. The view program which generated the update may need to retain the base data, as multiple view updates may depend on that base data. When all view updates generated for a given base update (e.g., base update 243) are committed, then the base update also can be allowed to be overwritten or be deleted, although usually the base data is preserved.

In typical operation, view programs and view data resources can operate in accordance with these examples. However, when there is a problem with communication, or with the operation of any component in the system (more broadly, any operational excursion), it may be the case that a view update committed to storage was not successfully acknowledged to its view program.

So, when a view program returns to normal operation, data corresponding to base updates may remain. Without having received and/or processed an acknowledgment, view programs cannot determine whether view updates for any of that base update data actually was committed but not acknowledged. Also, view data resource 135a, with only the updated view information, cannot determine whether any given view update corresponds to a particular outstanding base update.

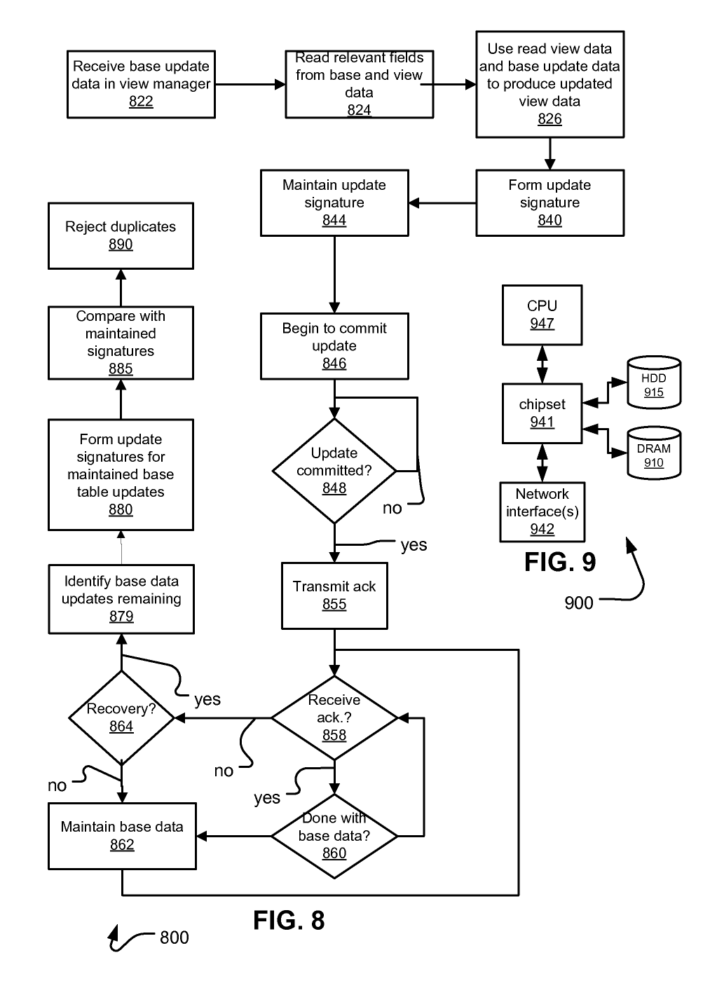

FIG. 8 illustrates an exemplary method 800 which comprises steps that are in accordance with the aspects described above. Method 800 includes that base update data (e.g., records of table 1) is received (822) in a view manager (FIGS. 2, 4-6). Each view manager reads 824 portions of the base data relevant to the view data which it is tasked to update (as explained with respect to FIGS. 4 and 5). The view manager in 824 also can read view data for which a current value is required to enable the view manager to perform an update (e.g., incrementing). Then, the view manager performs 826 operations to determine data to be used in any view updates arising from the received base update data.

As explained above, multiple fields of a view can be updated based on 1 base data update, and so on. The view manager forms 840 a signature unique to the combination of base and view data, and sequence of the update (as needed to distinguish from other updates), which also is reproducible. The signature is maintained 844, for example, at a resource operable to commit view table updates (see e.g., FIG. 1). At 846, such a resource begins to commit a given view update. Commitment in a given resource can include steps required to store and record the fact that the storage occurred. Upon view update commitment (can be represented as a waiting loop involving a determination 848 whether the update was committed), an acknowledgement is transmitted (855) to the view manager.

The view manager is responsive to receiving 858 the acknowledgement, and can determine 860 whether base data corresponding to the acknowledged view data has no more corresponding view updates pending. If view updates for that base data remain outstanding, then the base data can be maintained 862.

In the absence of receiving an acknowledgment, or more generally, in any operational excursion, a recovery may need to be commenced 864. Such recovery can include identifying 879 base data updates remaining in a queue or other storage associated with the view manager, which would correspond with unacknowledged view updates. If previously formed signatures for those updates do not remain accessible to the view manager, then those signatures can be formed 880 again. These signatures can then be compared (885) with stored signatures (e.g., at the view data resource 135a (see FIGS. 1-2)), and any duplicates identified by matching signatures can be rejected 890.

Thus, when returning to normal operation from an operational excursion, view programs can retry any non-confirmed view update, with the signatures that correspond to those updates. The signatures can be recreated from base data, or they can be stored with the base data. Then, view data resource 135a can use the signatures provided with the retried view updates, comparing those signatures with signatures of view updates that were committed, and determine whether or not an update for any such retried view update already was confirmed. View data resource can then acknowledge the commitment or report the retried update as an error.

The term “signature” was used at times to describe information defining a source of base data used to update an identified view table record, and sequence information for allowing distinguishing between multiple view updates prompted by one base data update, as well as sequential view updates from the same item of base data, where such base data is updateable (as opposed to addition/deletion of records). However, these signatures can also be identified with different names, such as “tag”, in that the signatures/tags are provided with non-idempotent view updates and are maintained in an association with the progress of their associated view updates during the processes of committing the updates to storage.

Also, processes and apparatuses were identified as performing certain functions herein. In this particular situation, the process of determining a value to be written into view data, in response to a base table update, is performed by a process separate from a process committing an updated value to view data storage. Such separation is not to imply that there is physical separation, although there may be. Instead, the relevant issue is that the signature information should remain available to a process that completes the commitment, such that the signature can be associated with view updates at a point where a failure condition would not interfere with the commitment of the transaction and the most basic understanding by the process that such commitment was achieved (e.g., that there is atomicity at some level between a view update commitment, and an annotation of such commitment with the signature associated with that view update.)

FIG. 9 illustrates components of a computer system 900 which may be used in executing computer code stored on computer readable media to execute methods according to the exemplary aspects described above. System 900 includes a CPU 947 communicating with a chipset 941, which communicates with one or more network interfaces 942, main working memory (e.g., DRAM) 910, and non-volatile storage (e.g., hard disk drives 915). System 900 would be appropriate primarily for executing programs that do not involve a great deal of human engagement, and as such would be appropriate for execution of programs for maintaining views, and databases according to the examples herein. Also, it would be understood that any given system 900 according to example system 900 can have a number of processors, various locations in which data can be stored, including network attached storage, fiber channel storage, and so on. Also, system 900 may execute database programs that provide functionality used by other programs perform aspects of the examples above. For example, a variety of database systems exist for maintenance of base tables, and logging updates to such base tables.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium, as it reads such data and instructions from that medium. Thus, any such connection is properly termed a computer-readable medium when embodying such data structures and/or code. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

1. A method for use in a database system comprising base tables and view tables derived from data in the base tables, comprising:
determining, in a view manager, responsively to an update to a base table, updates to view tables having data derived from the updated base table;
generating, in the view manager, a respective signature for each non-idempotent view table update, each signature uniquely identifying the updated base table, the view table for which the update is intended, and update sequence information;
providing the view table updates and the signatures to a database resource for commitment to storage of the view table updates, the database resource generating confirmations of commitments for provision to the view manager; and
recovering from an operational excursion by using the signatures in identifying any non-idempotent view table update that was committed prior to the failure, but for which confirmation of commitment was not acted upon by the view manager.

2. The method of claim 1, wherein causes for the confirmation not being acted upon by the view manager include that the view manager failed to receive the confirmation, or that the view manager was interrupted from acting upon a received confirmation.

3. The method of claim 1, wherein each signature uniquely identifies the updated base table to which it corresponds by indicating a base table name.

4. The method of claim 1, wherein each signature uniquely identifies the view table for which the update is intended by indicating a view table name.

5. The method of claim 1, wherein each signature uniquely identifies its corresponding updated base table by including a base table name and a key corresponding to a record in that base table.

6. The method of claim 5, wherein the update sequence information comprises sequence information indicative of a number of times that the base table record was updated.

7. The method of claim 1, wherein the recovering includes regenerating a respective signature for each non-idempotent view table update for which confirmation was not received, providing the regenerated respective signature and the view table update to the database resource, comparing, at the database resource, signatures corresponding to committed view table updates, and rejecting any view table update corresponding to a regenerated signature that matches any signature corresponding to a committed view table update.

8. The method of claim 1, wherein the recovering includes regenerating a respective signature for view updates corresponding to each base table update indicated as unfinished by a view manager responsible for generating those view updates.

9. The method of claim 1, wherein the update sequence information is incremented each time a view manager produces either a non-idempotent or an idempotent view table update.

10. The method of claim 1, wherein update sequence information includes information identifying each unique update for the identified base table and view table.

11. The method of claim 1, wherein the database resource, in committing view table updates to storage, compares respective signatures for each view table update with previously received signatures associated with other view table updates, and rejects any view table update as being duplicative if its signature matches a stored signature associated with a previously received view table update.

12. A method of committing to storage updates to derived data, comprising:
receiving a view data element to be written to an identified derived data view;
receiving a signature associated with the data element, the signature uniquely indicative of a base table record, a view table of which the view data element is a part, and sequence information relating to one or more of a number of times that the base table record was updated and a view sequence number;
initiating a process of committing the view data element to storage, the process including comparing the signature with signatures previously received for other view data elements; and
rejecting the view data element as being repetitive if the signature matches with any previously received signature.

13. The method of claim 12, wherein the view sequence number allows determining to which view element of a series of view elements to be updated the signature corresponds.

14. A computer readable medium storing computer readable code for a method of propagating updates to base data into derived data, comprising:
specifying one or more non-idempotent updates to records of one or more view tables, each view table associated with distinct identifier information, each update based on one or more records from one or more base tables, each base table associated with distinct identifier information, and each record associated with respective base record sequence numbers indicative of a number of times that base record has been updated;
for each of the updates to one or more view tables that are for the same view table, providing an index allowing discrimination between each update to the same view table; and
recovering from an operational excursion by using the view table identifier information, the base table identifier information, the base record sequence numbers and the numbers associated with view table records in determining whether each view table record update was committed to view table storage based on comparisons with similar information known to correspond with committed view table record updates.

15. A database system with base data tables and view data tables derived from the base data tables, comprising:
a first database resource storing a plurality of base tables;
a second database resource storing a plurality of view tables derived from data in the base tables, and configured for changing the view tables responsively to receiving view table updates and generating a respective change confirmation for each view table update for which a change was committed to the view tables; and
a view manager operable for receiving indications of updates to the base tables, for determining updates to be made to the view tables based on the updates to the base tables, for submitting the view table updates to the second database resource, and for generating a respective identifier for each non-idempotent view table update, and for responding to an operational excursion by resubmitting to the second database resource any view table update and its corresponding signature for which a commitment confirmation was not received by the view manager prior to the failure,
wherein the identifier comprises information identifying a base table whose update caused the view table update, the respective view table, and update sequence information for the respective view table, and
wherein the second database resource is operable to use the identifiers for determining which resubmitted view table updates correspond to base table updates already comprehended in the view tables, and reject such view table updates.

16. The system of claim 15, wherein the view manager responding to the operational excursion includes regenerating the identifiers based on maintained base table updates.

17. A method for use in updating derived data in database systems, comprising:
receiving base table information to be used as a basis for producing an update to an element of derived data;
using the base table information in producing the update;
producing identifier information for association with the update, the identifier information having characteristics including uniquely identifying the element of base data from among a plurality of base data elements, uniquely identifying the element of derived data to which the update pertains, and sequence information;
communicating the identifier information and update to a system for committing the update; and
recovering from an operational excursion by using the identifier information in determining whether derived data updates for the base table information were committed before the failure condition.

18. The method of claim 17, wherein the sequence information is indicative of a number of times that the element of base data was updated.

19. The method of claim 17, wherein the element of derived data is associated with a view table including a plurality of elements of derived data to be updated based on the received base table information, and the sequence information comprises information allowing discrimination between each of the plurality of elements of derived data to be updated.
